(19) United States
(12) Patent Application Publication
(10) Pub. No.: US 2008/0159254 A1
(43) Pub. Date: Jul. 3, 2008

(54) APPARATUS AND METHOD FOR ASSIGNING RESOURCES IN A WIRELESS COMMUNICATION SYSTEM

(75) Inventors: Hwan-Joon Kwon, Hwaseong-si (KR); Jin-Kyu Han, Seoul (KR); Jung-Soo Jung, Seongnam-si (KR); Dong-Hee Kim, Yongin-si (KR); Jae-Chon Yu, Suwon-si (KR); Yeon-Ju Lim, Seoul (KR)

Correspondence Address: THE FARRELL LAW FIRM, P.C., 333 EARLE OVINGTON BOULEVARD, SUITE 701, UNIONDALE, NY, 11553, US

(73) Assignee: Samsung Electronics Co., LTD., Suwon-si (KR)

(21) Appl. No.: 11/966,281

(22) Filed: Dec. 28, 2007

(30) Foreign Application Priority Data
Dec. 29, 2006 (KR) 2006-139058

(51) Int. Cl. H04B 7/212

(52) U.S. Cl. 370/347

(57) ABSTRACT

A method and apparatus for assigning resources to perform communication in a base station of a wireless communication system that assigns persistent resources and transmits a packet using the persistent resources are provided. A user buffer stores user data to be delivered to a terminal. A controller assigns the persistent resources, when a type of the data stored in the user buffer requires the persistent resources, sets one frame boundary using a predetermined number of transmission slots, and transmits an initial transmission sub-packet at a start slot of the frame boundary, or at a transmission slot upon receiving an Acknowledgement signal over a response channel in response to the transmitted packet. A transmission processor transmits, to the terminal, the user data stored in the user buffer, and Packet Start Indicator information.

### PRIORITY

This application claims priority under 35 U.S.C. § 119(a) to a Korean Patent Application filed in the Korean Intellectual Property Office on Dec. 29, 2006 and assigned Serial No. 2006-139058, the disclosure of which is incorporated herein by reference.

### BACKGROUND OF THE INVENTION

1. Field of the Invention

The present invention relates generally to an apparatus and method for assigning resources to perform communication in a wireless communication system, and in particular, to an apparatus and method for persistently assigning resources to perform communication.

2. Description of the Related Art

In general, a wireless communication system refers to a system that wirelessly connects user terminals to a network to perform communication. Therefore, the wireless communication system transmits/receives data using a specific radio frequency between base stations for connecting the user terminals to the network. Generally, in this configuration, wireless communication is performed only between the user terminals and the base station using a radio frequency, and other nodes to which the base station is connected are connected by the wire. In addition, the wireless communication system uses various multiple access techniques to allow multiple users to simultaneously perform communication. For example, Code Division Multiple Access (CDMA), Frequency Division Multiple Access (FDMA), and Time Division Multiple Access (TDMA) techniques are used as the multiple access techniques. The resources used for distinguishing the users in the wireless communication system include codes, frequencies, and time. Generally, the wireless communication system should efficiently assign the resources to provide services to more users.

The types of the wireless communication systems can be classified into a mobile communication system supporting only voice services, a mobile communication system supporting only data services, and a mobile communication system supporting both voice services and data services. However, there is a demand for a method capable of providing the voice services even in the mobile communication system supporting only the data services. To meet the demand, the mobile communication system supporting data services may provide voice services using a standard such as Voice over Internet Protocol (VoIP).

The voice service is a typical real-time service, and the data service is a non-real-time service. The real-time service includes not only the voice service, but also a music listening service, a broadcast service, a video call service, etc. These real-time services have characteristics that they are small in the amount of data and susceptible to the time delay. On the contrary, the data service, or the non-real-time service, has characteristics that it is large in the amount of data, generated intermittently, and less susceptible to the time delay.

Therefore, the wireless communication system supporting the data service assigns resources using the characteristics that the data service is generally large in the amount of data and generated intermittently, but is less susceptible to the time delay. Also, the wireless communication system supporting the real-time service is designed to persistently assign resources (Persistent Assignment or Persistent Resource Assignment) in order to provide the real-time service.

However, the wireless communication system supporting the data service, or the non-real-time service, is designed to non-persistently assign resources (Non-Persistent Assignment or Non-Persistent Resource Assignment) in order to efficiently use the resources. The persistent resource assignment scheme refers to a method for continuously assigning the fixed amount of resources to one user (or terminal) for a predetermined time, and transmitting/receiving data over the assigned resources for the time that the resources are assigned. However, the non-persistent resource assignment method can change the user to which it will assign resources, every data transmission unit.

As described above, the wireless communication system has been developed from a system supporting only one service into a system supporting various services. The wireless communication system is evolving into a system supporting not only the real-time service but also the non-real-time service. Therefore, there is a demand for the use of the persistent resource assignment scheme suitable to provide the real-time service even in the system supporting only the data service.

With reference to FIG. 1, a description will now be made of a process of providing a VoIP service in a wireless communication system that supports the data service.

The timing diagram shown by reference numeral 110 of FIG. 1 is an output of a vocoder for encoding voice data. Generally, when making a voice call, the speaking party does not continuously speak. Only upon receiving a voice signal (or audio signal), the vocoder encodes the received voice signal. Therefore, the vocoder's output period of FIG. 1 is divided into On-periods 111 and 113 where the vocoder outputs the encoded signal, and an Off-period 112 where the vocoder outputs no signal as it receives no voice signal. In the On-period, the vocoder outputs the encoded signal at intervals of a voice frame of about 20 msec according to its characteristic. Generally, because the wireless communication system supporting the data service uses the IP network, the signal encoded by the vocoder may be transferred with a different delay time according to its transmission path. Reference numeral 120 of FIG. 1 shows a delay time of the vocoder's encoded signal delivered to a base station over the IP network.

As shown in FIG. 1, the signal encoded by the vocoder is transmitted after it is delayed by the IP network by an initial packet delay time 121. Thereafter, when the signal encoded by the vocoder is transmitted, not all packets have the same delay time. That is, as shown by reference numeral 122, the packet inter-arrival time has a different delay time. The packet 130 transmitted over the IP network is composed of an encoded voice data part 131 and a header part 132.

A description will now be made of a process of transmitting the packet data using a persistent resource assignment scheme. FIG. 2 illustrates a control flow diagram of transmitting data using the persistent resource assignment scheme in a general wireless communication system. It should be noted herein that the control flow of FIG. 2 is limited to the process of assigning persistent resources to a particular user and transmitting data using the assigned persistent resources.

A base station assigns in step 200 persistent resources by which it will perform communication with a particular user. The resource assignment may differ in the assigned resources according to the multiple access schemes. For example, when the base station uses the CDMA scheme, the assigned resources may be a particular Walsh code, and when the base station uses the Orthogonal Frequency Division Multiple Access (OFDMA) scheme, the assigned resource can be a sub-carrier. After the resource assignment, the base station determines in step 202 if the transmission time has arrived. If it is determined in step 202 that the transmission time has arrived, the base station proceeds to step 204, and otherwise, proceeds to step 208 where it waits unit the next time. Upon proceeding to step 204, the base station determines if there is any data to transmit to a corresponding terminal in a transmission interval to which persistent resources are assigned. The term ‘transmission interval’ as used herein refers to Transmission Time Interval (TTI) or a slot. If it is determined in step 204 that there is data to transmit over the assigned resources in the current transmission interval, the base station proceeds to step 206 where it transmits the data using the persistently assigned resources. However, if there is no data to transmit, the base station proceeds to step 208 where it waits until the next transmission time.

FIG. 3 illustrates a timing diagram for a description of data transmission/reception performed when persistent resources are assigned to a particular terminal in a general wireless communication system.

In FIG. 3, the horizontal axis indicates the passage of time, and the vertical axis indicates resources. As described above, the resources may differ according to the multiple access scheme used. As shown in FIG. 3, for a user A, the base station assigns particular resources at a particular time and allows the user A to use the assigned resources. For a user B, the base station assigns other particular resources at another particular time and allows the user B to use the assigned resources. Alternatively, the base station can utilize the interlace structure in which it uses the same resources at different times. This will be described with reference to FIG. 1. The resources persistently assigned to the user A are defined to be used only at the particular time. Therefore, it is possible to assign the same resources to another user at the time for which the user A does not use the resources. This is because of the use of the transmission delay time and the Hybrid Automatic Repeat reQuest (HARQ) scheme for the data. More specifically, the resources assigned to the user A can be used in TTI 301 and TTI 302. In the TTIs between 301 and 302, which are not assigned to the user A, the base station can assign the same resources to other users and allows them to use the assigned resources.

The HARQ scheme is one of the important technologies used for increasing the transmission reliability and the data throughput in the wireless communication system supporting the data service. Because the data service is generally provided in the packet form, the data service will be referred to herein as ‘packet data’.

The HARQ scheme refers to the technology that uses Automatic Repeat reQuest (ARQ) technology and the Forward Error Correction (FEC) technology together. The ARQ technology is a technology popularly used in the wire/wireless data communication systems, and its transmitter assigns sequence numbers to transmission data packets according to a predefined rule before transmission. Then a data receiver sends a retransmission request for the missing packets, if any, among the received packets to the transmitter using the sequence numbers. In this way, the ARQ technology can achieve the reliable data transmission. Next, the FEC technology adds redundant bits to the transmission data according to the specific rule such as convolutional encoding or turbo encoding before transmission. By transmitting the data in this manner, the FEC technology deals with the noises occurring in the data transmission/reception process and/or the errors occurring in the fading environment, thereby demodulating the originally transmitted data.

In the wireless communication system using the combined HARQ and the FEC technology, the data receiver performs Cyclic Redundancy Check (CRC) on the data decoded by performing an inverse FEC process on the received data. The data receiver determines the presence/absence of errors through the CRC. If there are no errors, the receiver feeds back an Acknowledgement (ACK) to the transmitter, so that the transmitter may transmit the next data packet. However, if it is determined as a result of the CRC check that there is an error in the received data, the receiver feeds back a Non-Acknowledgement (NACK) so that the transmitter may retransmit the previously transmitted packet.

Through this process, the receiver combines the retransmitted packet with the previously transmitted packet, thereby obtaining energy gain. In this way, the HARQ technology, compared to the ARQ technology without the combining process, can obtain noticeably improved performance. In this HARQ process, to transmit one packet, first transmission (initial transmission) is performed and multiple retransmissions may be performed according to the ACK/NACK feedback. For convenience, in this process, an initial transmission packet and a retransmission packet(s) transmitted for one-packet transmission each will be referred to as sub-packet. That is, the one packet is composed of the initial transmission sub-packet, a second sub-packet (sub-packet corresponding to the first retransmission), a third sub-packet (sub-packet corresponding to the second retransmission), etc.

In FIG. 3, the part shown by reference numeral 321 indicates an ACK/NACK feedback for the HARQ support. As described above, the receiver feeds back the decoding result. Commonly, the transmission for the initial transmission packet is made in an arbitrary slot in the persistently assigned resources, as shown in FIG. 3. Therefore, the data receiver cannot determine the point to which the initial transmission time corresponds. Reference numerals 311 to 314 of FIG. 3 show the data demodulation process of the user A. More specifically, reference numerals 311 to 314 show that the terminal of the user A attempts data demodulation over the persistently assigned resources at the time of reference numeral 306.

However, because the terminal of user A has no information on the start point of the packet transmission, i.e., the time where the initial transmission is made, the terminal performs a packet demodulation operation taking all of the several possibilities into account. That is, under the assumption that the initial transmission has been made at the time at 306, user A's terminal attempts packet demodulation only with the signal received at the time at 306. Upon a failure in the data demodulation, the receiver assumes the next possibility that the initial transmission was made at the previous time 305 and the first retransmission sub-packet is being transmitted at the time at 306. At this moment, whether the data demodulation has been successfully made is generally checked by CRC. As shown by reference numeral 311, the receiver combines the signal received at the time at 306 with the signal received at the time at 305 according to a specific HARQ process and attempts data demodulation for the combined signal. Thereafter, the receiver checks whether the demodulation has been successfully made. If the data demodulation is failed even in this process, the receiver combines all the signals received at the times at 306, 305 and 304, as shown by reference numeral 312. That is, under the assumption that the sub-packet received at the time at 306 is the second retransmission sub-packet (third sub-packet), the receiver attempts demodulation. In this manner, the receiver performs the demodulation process on all the possibilities. The check of the demodulation possibilities is made taking the maximum number of retransmissions into account. That is, if the maximum number of retransmissions is assumed to be 4, a total of 5 sub-packets including the initial transmission packet can be transmitted for the same packet. In this context, as shown in FIG. 3, user A's terminal attempts the data demodulation for the 5 possible cases at the time at 306. It is not necessary that the data demodulation attempt for the above-described possibilities should be made in the above-stated order.

When data is transmitted over the persistently assigned resources as described above, the data demodulation process of the terminal may be too complex. This is because, as described above, the terminal cannot determine the initial transmission time of the data received over the persistently assigned resources. Due to this, the receiver in the wireless communication system may fail to normally receive the initially transmitted packet, probably causing the frequent occurrence of the retransmission. The frequent occurrence of the retransmission may reduce the entire throughput.

### SUMMARY OF THE INVENTION

An aspect of the present invention is to solve at least the problems and/or disadvantages and to provide at least the advantages described below. Accordingly, an aspect of the present invention is to provide an apparatus and method capable of efficiently using the persistently assigned resources in a wireless communication system.

Another aspect of the present invention is to provide an apparatus and method capable of facilitating demodulation of data packets in a wireless communication system.

Another aspect of the present invention is to provide an apparatus and method capable of increasing the entire efficiency in a wireless communication system.

In accordance with one aspect of the present invention, there is provided an apparatus for assigning resources to perform communication in a base station of a wireless communication system that assigns persistent resources and transmits a packet using the persistent resources. The apparatus includes a user buffer for storing user data to be delivered to a terminal; a controller for assigning the persistent resources, when a type of the data stored in the user buffer requires the persistent resources, setting one frame boundary using a predetermined number of transmission slots, and transmitting an initial transmission sub-packet at a start slot of the frame boundary, or at a transmission slot upon receiving an Acknowledgement (ACK) signal over a response channel in response to the transmitted packet; and a transmission processor for transmitting, to the terminal, the user data stored in the user buffer, and Packet Start Indicator (PSI) information.

In accordance with another aspect of the present invention, there is provided a method for assigning resources to perform communication in a base station of a wireless communication system that assigns persistent resources and transmits a packet using the persistent resources. The method includes setting and assigning a frame boundary in units of a predetermined number of transmission slots, when there is a need for assignment of persistent resources to a specific terminal; and transmitting an initial transmission sub-packet at a start slot of the frame boundary, or upon receiving an Acknowledgement (ACK) signal over a response channel in response to the transmitted packet.

In accordance with further another aspect of the present invention, there is provided an apparatus for receiving assigned resources to perform communication in a terminal of a wireless communication system that assigns persistent resources and transmits a packet using the persistent resources. The apparatus includes a reception processor for receiving a control channel and a packet channel, and performing demodulation and decoding thereon; a controller for receiving persistent resources and frame boundary information including a predetermined number of transmission slots, controlling the reception processor to receive an initial sub-packet at a start slot of the frame boundary, or at a time immediately after transmitting an Acknowledgement (ACK) signal over a response channel, and providing packet reception result information; and a transmission unit for transmitting the packet reception result information from the controller over the response channel.

In accordance with yet another aspect of the present invention, there is provided a method for receiving assigned resources to perform communication in a terminal of a wireless communication system that assigns persistent resources and transmits a packet using the persistent resources. The method includes receiving persistent resources and frame boundary information including a predetermined number of transmission slots, and receiving an initial sub-packet at a start slot of the frame boundary, or at a time immediately after transmitting an Acknowledgement (ACK) signal over a response channel.

### BRIEF DESCRIPTION OF THE DRAWINGS

The above and other aspects, features and advantages of the present invention will become more apparent from the following detailed description when taken in conjunction with the accompanying drawings in which:

FIG. 1 illustrates a process of providing a VoIP service in a wireless communication system supporting a data service;

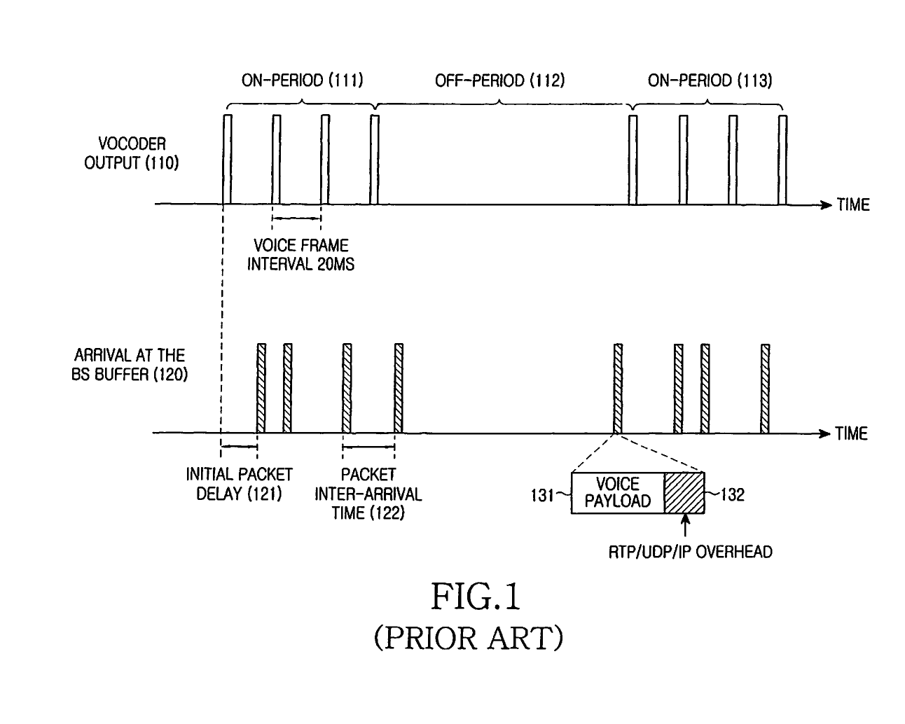

FIG. 2 illustrates a control flow diagram of transmitting data using the persistent resource assignment scheme in a general wireless communication system;

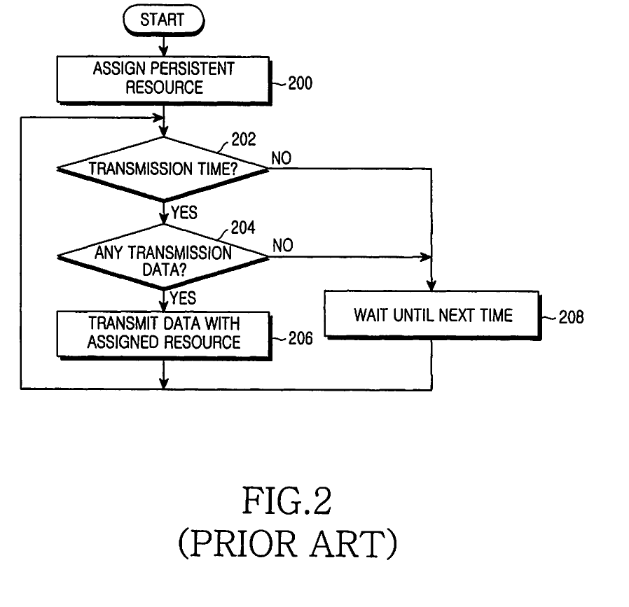

FIG. 3 illustrates a timing diagram for a description of data transmission/reception performed when persistent resources are assigned to a particular terminal in a general wireless communication system;

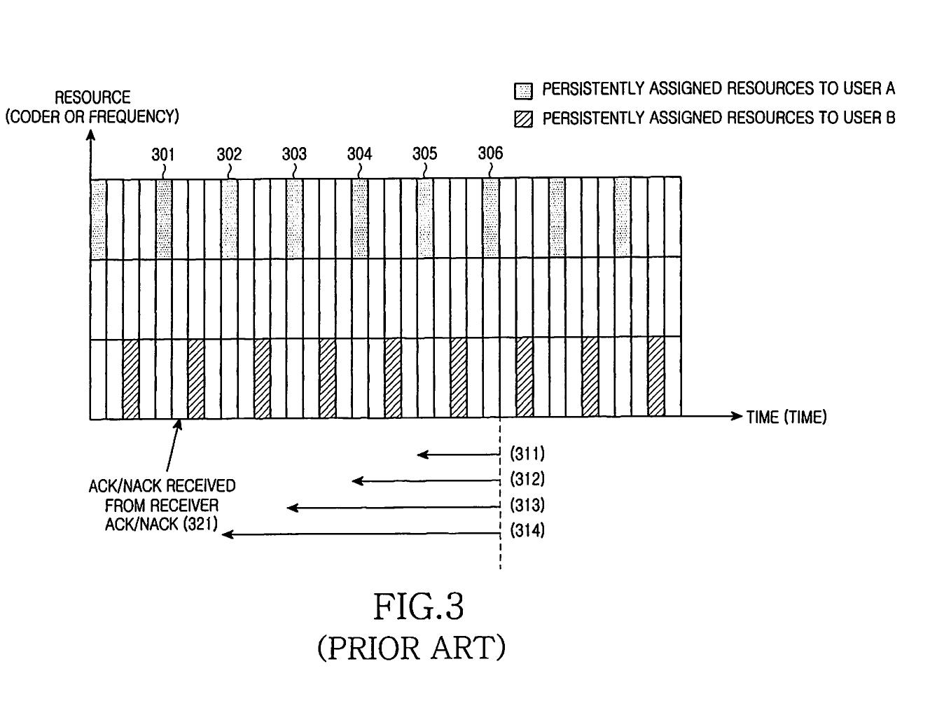

FIG. 4 illustrates an internal structure of a base station for transmitting packet data to a user according to the present invention;

FIG. 5 illustrates an internal structure of a receiver (or terminal) for receiving packet data according to the present invention;

FIG. 6 illustrates a timing diagram for persistently assigned resources according to the present invention;

FIG. 7 illustrates a control flow diagram in which a base station transmits data using persistently assigned resources according to the present invention; and

FIG. 8 illustrates a control flow diagram in which a terminal receives data using persistently assigned resources according to the present invention.

### DETAILED DESCRIPTION OF THE PREFERRED EMBODIMENTS

Preferred embodiments of the present invention will now be described in detail with reference to the annexed drawings. In the following description, a detailed description of known functions and configurations incorporated herein has been omitted for clarity and conciseness.

The method of the present invention previously defines the time at which the base station can perform initial transmission. Therefore, the present method allows the base station to transmit the initial transmission packet only at the predetermined time, and to separately transmit the signaling indicating the initial transmission packet to the terminal when it intends to transmit the initial transmission packet at the time other than the predetermined time. There are the following two possible occasions in which the initial transmission packet can be transmitted, which are provided by the present invention.

(1) The base station can transmit the initial transmission packet in the occasion where it has transmitted a sub-packet to the terminal at the immediately previous slot and has received an Acknowledgement (ACK) as a feedback in response to the sub-packet.

(2) The base station can transmit the initial transmission packet in the occasion where a frame boundary is determined for the persistently assigned resources and the corresponding time is a start point of the frame boundary.

Therefore, when the base station intends to transmit the initial transmission packet even in the occasion other than the above two occasions, the base station should separately transmit the separate signaling indicating that it is transmitting the initial transmission packet at the current slot. The ‘signaling’ will be referred to herein as a Packet Start Indicator (PSI), and the physical channel over which the PSI is transmitted will be referred to herein as a Packet Start Indicator Channel (PSICH) or a Forward Packet Start Indicator Channel (F-PSICH).

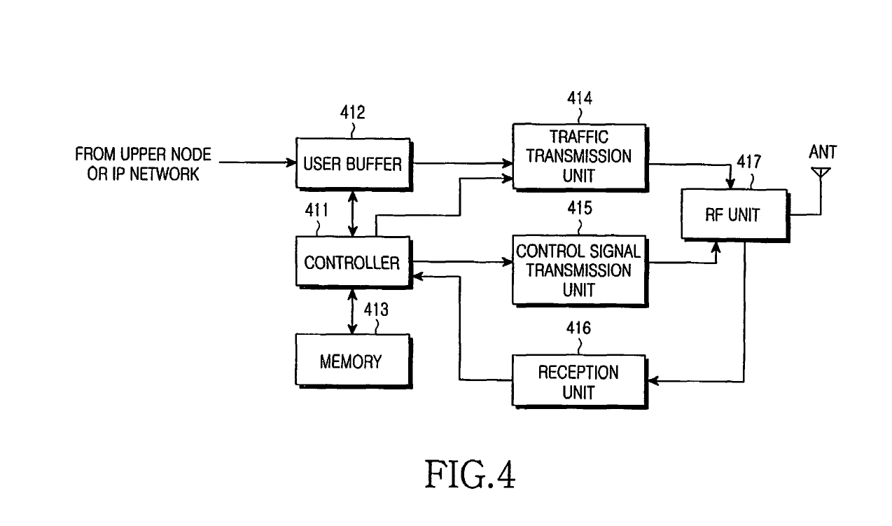

FIG. 4 illustrates an internal structure of a base station for transmitting packet data to a user according to a preferred embodiment of the present invention. It should be noted that the block diagram of FIG. 4 is limited to the block structure of the base station for transmitting packet data to a user.

A user buffer 412 receives and stores the data to be provided from the upper node or (Internet Protocol) IP network to the user. The stored data is provided to a traffic transmission unit 414 under the control of a controller 411. The traffic transmission unit 414, under the control of the controller 411, encodes and modulates the data received from the user buffer 412. The term ‘encoding’ as used herein means FEC encoding. A control signal transmission unit 415 encodes and modulates the control signal received from the controller 411, and outputs the resulting signal to a Radio Frequency (RF) unit 417. Herein, the control signal includes a PSI transmitted over a PSICH according to the present invention. The RF unit 417 converts the signals received from the traffic transmission unit 414 and the control signal transmission unit 415 into an RF signal, and transmits the RF signal to the corresponding terminal via an antenna ANT using assigned resources.

In addition, the RF unit 417 frequency down-converts a signal received from the antenna ANT, and provides the frequency down-converted signal to a reception unit 416. Then the reception unit 416 demodulates and decodes the received signal and provides the resulting signal to the controller 411. The traffic transmission unit 414, the control signal transmission unit 415 and the RF unit 417 constitute a transmission processor.

The controller 411 controls the overall operation of the base station, and it should be noted herein that the controller 411 is set to perform an operation of a scheduler, as well. Further, the controller 411 determines the amount of data stored in the user buffer 412 and if there is any data stored in the user buffer 412, and performs scheduling depending thereon. The controller 411 determines at which time and in which way the data transmission should be made. The controller 411 stores in a memory 413 the control data for the overall control and the data generated during the control. A preferred embodiment achieved by the controller 411 according to the present invention will be described in more detail with reference to the following timing diagram and control flow diagrams.

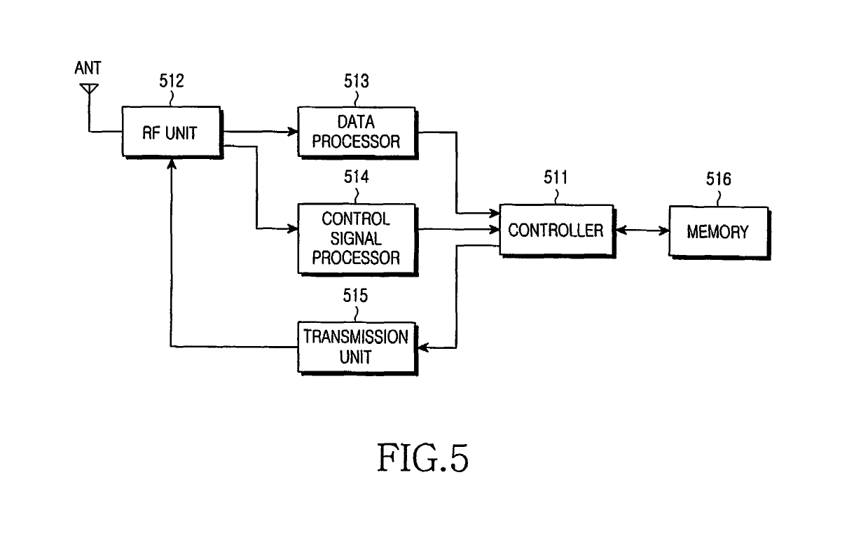

FIG. 5 illustrates an internal structure and operation of a receiver (or terminal) for receiving packet data according to a preferred embodiment of the present invention. A signal received via an antenna ANT is frequency down-converted in an RF unit 512. The RF unit 512 outputs the user data in the frequency down-converted signal to a data processor 513, and outputs the control signal in the frequency down-converted signal to a control signal processor 514. The data processor 513 performs demodulation and decoding on the user data, and provides the decoding result thereon to a controller 511. The term ‘decoding result’ as used herein means the Cyclic Redundancy Check (CRC) result. That is, the data processor 513 provides the information indicating if the received packet is ‘Good’ or ‘Bad’. The ‘Good’ received data is provided to the user. The control signal processor 514 demodulates and decodes the received control signal, and provides the resulting signal to the controller 511. Herein, the control signal includes a PSI received over a PSICH according to the present invention. The RF unit 512, the data processor 513 and the control signal processor 514 constitute a reception processor.

A transmission unit 515, under the control of the controller 511, encodes and/or modulates the data to be transmitted over the uplink and the ACK/NACK information reported over an uplink response channel or ACK channel (ACKCH), and provides the result to the RF unit 512.

The controller 511 controls the overall control of the terminal, and controls packet reception using the persistently assigned resources according to the present invention. A detailed description of the control will be made with reference to the accompanying drawings. The control data for the controller 511, the user data, and the received data can be stored in a memory 516.

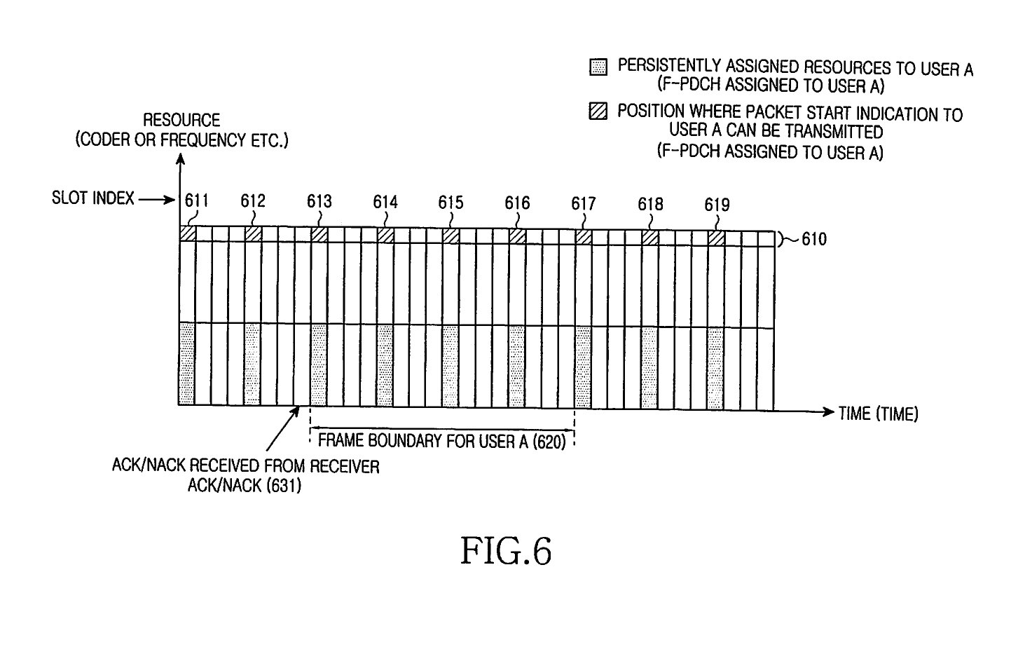

FIG. 6 illustrates a timing diagram for persistently assigned resources according to a preferred embodiment of the present invention. With reference to FIG. 6, a description will now be made of the exemplary use of persistently assigned resources according to the present invention.

As shown in FIG. 6, the horizontal axis indicates the continued time and the vertical axis indicates resources. The term ‘resource’ as used herein can be a code or a frequency according to the multiple access scheme. Shown in FIG. 6 is a frame boundary 620 assigned to a particular user. Therefore, initial transmission of a packet can be made on the basis of the frame boundary. According to the present invention, when the persistently assigned resources are used, there is a channel 610 used for indicating transmission/non-transmission of an initial transmission packet irregularly. That is, the channel 610 is a PSICH channel assigned to a user A's terminal, over which the PSI can be transmitted.

It is assumed that the interlace structure is applied to the channel 610. Therefore, slot indexes are shown such that they are transmitted to user A's terminal at predetermined intervals (at intervals of 4 slots in FIG. 6) as shown by reference numerals 611 to 619. It can be noted from FIG. 6 that the resources assigned to user A's terminal are the times corresponding to the slot indexes 611 to 619. Because the wireless communication system of the present invention supports the Hybrid Automatic Repeat reQuest (HARQ) scheme, when packet data is transmitted, ACK/NACK information 631 is received from a receiver over an ACKCH after a lapse of a predetermined time. In this way, initial transmission or retransmission is determined.

With reference to control flow diagrams, a detailed description will now be made of a transmission and reception process performed in the foregoing system.

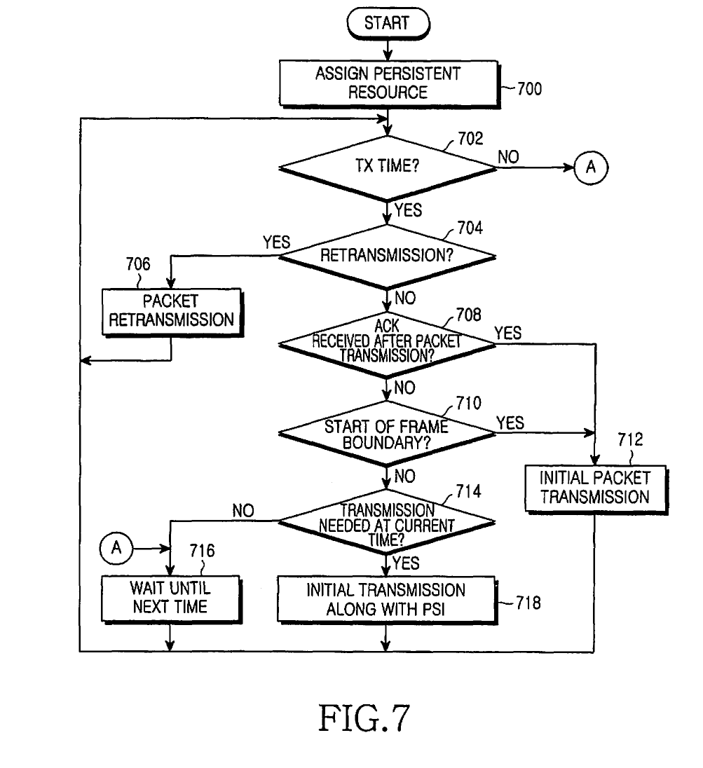

FIG. 7 illustrates a control flow diagram in which a base station transmits data using persistently assigned resources according to a preferred embodiment of the present invention. It should be noted in FIG. 7 that assignment of persistent resources to a particular terminal is determined, and the control process is performed on one particular terminal. That is, the control process corresponds to a part of the entire scheduling operation for all terminals in the base station.

In step 700, a controller 411 of a base station persistently assigns resources, the amount of which is needed for communication, to a particular user terminal (Persistent Assignment). Here, the controller 411 previously designates a frame boundary for the user terminal. That is, the frame boundary 620 described in FIG. 6 is set. The frame boundary 620 can be previously determined when the negotiation for initial communication is carried out between the terminal and the base station. In an alternative way, the frame boundary 620 can be determined by a predetermined rule.

After the resource assignment, the controller 411 of the base station determines in step 702 if the transmission time has arrived. In the event that it is determined in step 702 that the transmission time has arrived, the controller 411 proceeds to step 704, and in the event that the transmission time has not arrived, the controller 411 proceeds to step 716 where it waits until the next time. Upon proceeding to step 704, the controller 411 determines if the current time is a retransmission time. The controller 411 determines that the current time is a retransmission time, when a sub-packet was transmitted at the previous slot among the persistently assigned resources in the same HARQ interlace and Non-Acknowledgement (NACK) is received over a response channel in response to the sub-packet. The ‘same HARQ interlace’ as used herein refers to the interlace where one HARQ process is performed, and indicates the transmission times assigned to the user A's terminal, shown in FIG. 6. At this moment, the controller 411 can determine if the current transmission has exceeded the maximum number of retransmissions. When the current transmission has not arrived at the predetermined maximum number of retransmissions, the controller 411 performs retransmission. The process of determining the maximum number of retransmissions is not shown in FIG. 7. In the event that it is determined in step 704 that there is a need for the retransmission, the controller 411 proceeds to step 706 where it generates a retransmission sub-packet, and retransmits the generated sub-packet using the assigned resources.

However, in the event that it is determined in step 704 that there is no need for the packet retransmission, the controller 411 needs initial transmission because the current time is already the transmission time. In this case, it is possible to further provide a process of determining if there is a need for performing the initial transmission. The process of determining if there is a need for performing the initial transmission can be a process of determining by the controller 411 if there is any data in a user buffer 412 to transmit to a corresponding user.

When there is a need for initial transmission in foregoing process, the controller 411 determines in step 708 if it has transmitted a sub-packet at the previous slot, i.e., at the immediately previous slot in the same HARQ interlace, and has received an ACK in response to the transmitted sub-packet. In the event that it is determined in step 708 that the ACK has been received, the controller 411 proceeds to step 712 where it transmits an initial sub-packet using the persistently assigned resources that it assigned to the user in step 700. However, in the event that it is determined in step 708 that the controller 411 has failed to receive the ACK, or has transmitted no packet at the previous time, the controller 411 determines in step 710 if the current time slot is a start point of the frame boundary 620 described in FIG. 6. In the event that it is determined in step 710 that the current time slot is the start point of the frame boundary 620, the controller 411 proceeds to step 712 where it performs initial transmission on the sub-packet as described above.

However, when the current time slot is not the start point of the frame boundary 620, the controller 411, because it should perform initial transmission, determines in step 714 if it should perform initial transmission at the current time. That is, the controller 411 determines if the corresponding packet is the initial transmission packet that it necessarily should transmit at this slot even by transmitting a PSI. This determination is made because the transmission of the PSI needs to use the power, causing overhead on the entire system. Generally, the determination of step 714 is made taking into account the packet delay time (packet delay) and Quality of Service (QoS) of the transmission packet. Therefore, in the event that it is determined in step 714 that it is necessary to perform initial transmission, the controller 411 proceeds to step 718 where it performs initial transmission on both the PSI signal and the sub-packet. Similarly, in this case, the controller 411 transmits the packet using the resources assigned in step 700, and transmits the PSI over a PSICH. However, in the event that it is determined in step 714 that it is not necessary to transmit the sub-packet at the current time, the controller 411 proceeds to step 716 where it waits until the next transmission time.

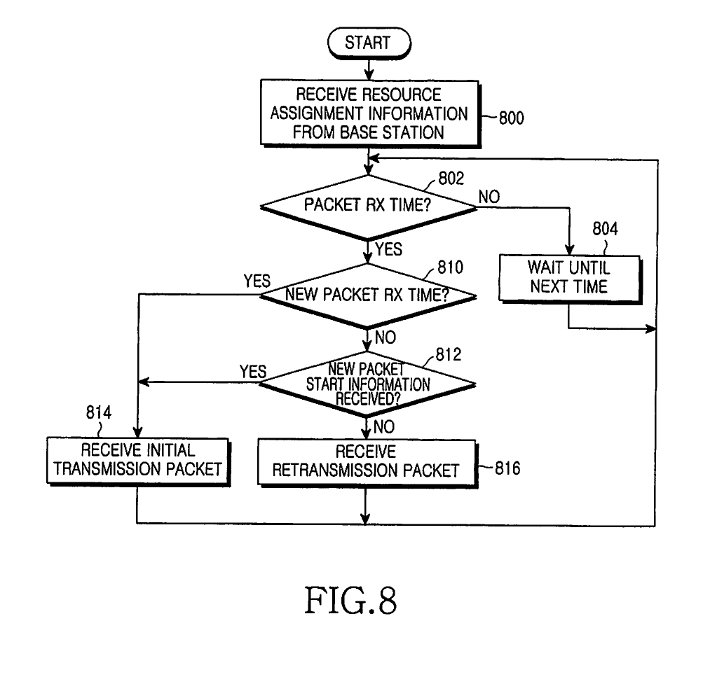

FIG. 8 illustrates a control flow diagram showing a method in which a terminal receives data using persistently assigned resources according to a preferred embodiment of the present invention. In step 800, a controller 511 of a terminal receives resource assignment information necessary for data reception, from a base station. The resources assigned herein are persistently assigned resources. In this case, the controller 511 can receive information on the above-described frame boundary 620, as well. As to the information on the frame boundary 620, the controller 511 can be assigned it during initial communication negotiation and store it in a memory 516. In an alternative way, the controller 511 can automatically determine the information on the frame boundary 620 according to a predetermined rule. However, the information on the frame boundary between the base station and the terminal is the information that should be shared. Thereafter, the controller 511 determines in step 802 if the current time slot is the time at which it receives a packet. This determination can be made by determining if the current slot exists in the same HARQ interlace assigned from the base station. In the event that it is determined in step 802 that the current time is the time at which it receives a packet, the controller 511 proceeds to step 810. Otherwise, the controller 511 proceeds to step 804 where it waits until the next slot.

Upon proceeding to step 810, the controller 511 determines if the current slot is the slot where the transmission on a new packet can be carried out. The initial packet transmission can be carried out in at least one of the following three cases:

(1) The initial packet transmission can be carried out when the corresponding slot is the start point of the frame boundary.

(2) The initial packet transmission can be carried out when the terminal has received a sub-packet from the base station at the immediately previous slot in the same HARQ interlace and has fed back an ACK to the base station as it has succeeded in the demodulation on the received packet.

(3) The initial packet transmission can be carried out when the terminal has received a PSI over a PSICH at the current slot.

Generally, the controller 511 of the terminal can previously get the time information of the cases (1) and (2). However, the terminal cannot previously acquire the time information of the case (3). Therefore, in the determination process of step 810, the controller 511 determines if the current case corresponds to any one of the cases (1) and (2). When the current case corresponds to any one of the two cases, the controller 511 proceeds to step 814 where it performs an operation of receiving the initial transmission packet. That is, the controller 511 controls a reception processor to perform a data demodulation process on the initial transmission packet using the signal received over the persistently assigned resources.

However, when the current slot is not the new-packet reception time, the controller 511 determines in step 812 if it has received new-packet start information. That is, the controller 511 determines where a PSI is received over a PSICH. In the event that it is determined in step 812 that a PSI is received, the controller 511 proceeds to step 814 where it performs the foregoing initial transmission packet reception operation. However, upon failure to receive the PSI, the controller 511 proceeds to step 816 where it performs an operation of receiving a retransmission packet. That is, the controller 511 combines the previously received sub-packet with the currently received sub-packet, and performs demodulation and decoding thereon.

As is apparent from the foregoing description, the application of the present invention to the wireless communication system that transmits/receives packets using persistently assigned resources can reduce the demodulation and decoding complexity of the terminal, and can also reduce the number of retransmissions that occur due to the failure to receive the initial transmission packet, thereby contributing to an increase in the entire efficiency.

While the invention has been shown and described with reference to a certain preferred embodiment thereof, it will be understood by those skilled in the art that various changes in form and details may be made therein without departing from the spirit and scope of the invention as defined by the appended claims.

What is claimed is:

1. An apparatus for assigning resources to perform communication in a base station of a wireless communication system that assigns persistent resources and transmits a packet using the persistent resources, the apparatus comprising:
a controller for assigning the persistent resources setting one frame boundary using a predetermined number of transmission slots, and transmitting an initial transmission sub-packet at a start slot of the frame boundary, or at a transmission slot upon receiving an Acknowledgement (ACK) signal over a response channel in response to the transmitted packet; or upon transmitting a Packet Start Indication (PSI) information with the initial transmission packet when there is a need for initial transmission at a transmission slot other than an initial packet transmission time to the terminal to which the persistent resources are assigned.

2. The apparatus of claim 1, wherein the PSI information is transmitted over a Packet Start Indicator Channel (PSICH).

3. The apparatus of claim 1, further comprising a reception unit for receiving reception result information for the transmitted packet over the response channel.

4. A method for assigning resources to perform communication in a base station of a wireless communication system that assigns persistent resources and transmits a packet using the persistent resources, the method comprising:
setting and assigning a frame boundary in units of a predetermined number of transmission slots, when there is a need for assignment of persistent resources to a specific terminal; and
transmitting an initial transmission sub-packet at a start slot of the frame boundary, or upon receiving an Acknowledgement (ACK) signal over a response channel in response to the transmitted packet, or upon transmitting a Packet Start Indication(PSI) information with the initial transmission packet when there is a need for initial transmission at a transmission slot other than an initial packet transmission time to the terminal to which the persistent resources are assigned.

5. The method of claim 4, wherein the PSI information is transmitted over a Packet Start Indicator Channel (PSICH).

6. The method of claim 4, further comprising:
performing retransmission on the previously transmitted packet upon receiving Non-Acknowledgement (NACK) information over a response channel in response to the previously transmitted packet before expiration of the frame boundary.

7. The method of claim 6, wherein the packet retransmission is performed using a Hybrid Automatic Repeat reQuest (HARQ) scheme.

8. The method of claim 7, further comprising:
stopping the retransmission when there is a change in the frame during the retransmission based on the HARQ scheme.

9. An apparatus for receiving assigned resources to perform communication in a terminal of a wireless communication system that assigns persistent resources and transmits a packet using the persistent resources, the apparatus comprising:
a reception processor for receiving a control channel and a packet channel, and performing demodulation and decoding thereon;
a controller for receiving persistent resources and frame boundary information including a predetermined number of transmission slots, controlling the reception processor to receive an initial sub-packet at a start slot of the frame boundary, or at a time immediately after transmitting an Acknowledgement (ACK) signal over a response channel, or upon receiving Packet Start Indicator (PSI) information at a transmission slot other than an initial packet transmission time.

10. The apparatus of claim 9, wherein the Packet Start Indicator (PSI) information is received over a Packet Start Indicator Channel (PSICH).

11. A method for receiving assigned resources to perform communication in a terminal of a wireless communication system that assigns persistent resources and transmits a packet using the persistent resources, the method comprising:
receiving persistent resources and frame boundary information including a predetermined number of transmission slots, and
receiving an initial sub-packet at a start slot of the frame boundary, or at a time immediately after transmitting an Acknowledgement (ACK) signal over a response channel, or upon receiving an initial sub-packet upon receiving Packet Start Indicator (PSI) information at a transmission slot other than an initial packet transmission time.

12. The method of claim 11, wherein the PSI information is received over a Packet Start Indicator Channel (PSICH).

13. The method of claim 1 further comprising:
receiving a retransmission packet after reporting a Non-Acknowledgement (NACK) for the received packet as a check result on the initial transmission packet.

14. The method of claim 13, wherein the packet retransmission is performed using a Hybrid Automatic Repeat reQuest (HARQ) scheme.
